(19) United States
(12) Patent Application Publication
(10) Pub. No.: US 2017/0153497 A1
(43) Pub. Date: Jun. 1, 2017

(54) BACKLIGHT MODULE

(71) Applicant: Shenzhen China Star Optoelectronics Technology Co. Ltd., Shenzhen, Guangdong (CN)

(72) Inventor: Yong FAN, Shenzhen, Guangdong (CN)

(73) Assignee: Shenzhen China Star Optoelectronics Technology Co. Ltd., Shenzhen, Guangdong (CN)

(21) Appl. No.: 14/785,610

(22) PCT Filed: Sep. 25, 2015
(86) PCT No.: PCT/CN2015/090767

§ 371 Date: Oct. 19, 2015

(30) Foreign Application Priority Data
Sep. 22, 2015 (CN) 201510608698.X

(51) Int. Cl. G02F 1/1335; F21V 8/00

(52) U.S. Cl. CPC G02F 1/133602; G02B 6/0078; G02B 6/0055; G02B 6/0085; G02B 6/0051; G02F 2001/133614

(57) ABSTRACT

A backlight module includes a back plate having an opening on a top, first reflective sheet on a bottom of the back plate, a plurality of light guiding plates spaced apart on the first reflective sheet, a backlight source component, and an optical film set arranged over the opening on the top of the back plate. The backlight source component includes a wedge-shaped heat sink and light sources fixed on two slopes adjacent to the heat sink, and the backlight source component is arranged within a gap between the two adjacent light guiding plates. The above backlight module contributes to the narrow border and super thin design, and the reduced cost. At the same time, the backlight module provides better consistent backlight and greatly reduces of light-mixing distance. In addition, the dark stripes in a rim of the backlight module may be efficiently eliminated.

### BACKGROUND OF THE INVENTION

1. Field of the Invention

The present disclosure relates to liquid crystal display technology, and more particularly to a backlight module.

2. Discussion of the Related Art

With respect to traditional Thin Film Transistor-Liquid Crystal Display (TFT-LCD), as the panel of the TFT-LCD does not emit light itself, usually, a light source is needed such that the TFT-LCD can display. The light source may include a backlight light source and a reflective light source. As the backlight light source may be slightly affected by the environment, and thus has been the main trend for the TFT-LCDs.

The light source of TFT-LCD evolves from the Cold Cathode Fluorescent Lamp (CCFL) and Light-Emitting Diode (LED). As the LEDs are characterized by attributes such as small dimension, quick response, long life cycle, not fragile, high color range, and a variety of packaging bodies, and thus are very popular.

The LED backlight modules include edge-type and direct-lit types. The edge-type backlight module includes the advantages such as low power consumption and thin. However, such type has to cooperatively operate with the light guiding plate, which may result in heavy weight and high manufacturing cost. As the direct-lit backlight module may include a few light sources (with prism) and the light guiding plate is not needed, the manufacturing cost is relatively low. But the light box may increase the thickness of the backlight module.

The luminescence spectrum of the full width at half maximum (FWHM) of the Quantum dot (QD) fluorescent is narrow, i.e., 20˜40 nm, the purity of the color is pretty high, and thus is the fluorescent powder having the highest saturation. The QD fluorescent powder is composited by chemical liquid and may not be uniformly distributed from silicon gel. In addition, the QD fluorescent powder is fragile to water and oxygen, and quench effect may be serious. When being packaged within the LED, the light emitting brightness is low and the endurance is also low, and thus may not be mass production. Currently, only the intermediate QD fluorescent powder may be adopted in mass production, wherein the QD thin film (QDEF) manufactured by 3M is one famous product, which adopts interlayer structure encapsulating the QD within optical films, and may be operated cooperatively with other optical thin films. Another famous product is the “QD tube” manufactured by QD vision, which encapsulating the QD fluorescent powder within a glass tube. The QD tube is arranged in front of the LED and is supported by a supporting device. As the QD film is restricted by QD film, and may not be made in a large-scale, i.e., 100 inches, which limits the applications of the QD film on large-scale products. QD tube may only be incorporated into edge-type backlight module, but the curved glass tube is difficult to assemble and may be damaged easily. In addition, the largest size capable of incorporating such products is 98 inches. Basing on the above reasons, the conventional optical design solution cannot implement the QD technology on large-scale products.

### SUMMARY

In view of the above, the present disclosure includes a backlight module of low manufacturing cost and can be easily implemented.

In one aspect, a backlight module includes: a back plate having an opening on a top, first reflective sheet on a bottom of the back plate, a plurality of light guiding plates spaced apart on the first reflective sheet, a backlight source component, and an optical film set arranged over the opening on the top of the back plate, the backlight source component comprising a wedge-shaped heat sink and light sources fixed on two slopes adjacent to the heat sink, and the backlight source component being arranged within a gap between the two adjacent light guiding plates.

Wherein the two surfaces of the two light guiding plates facing toward each other are respectively parallel to the two slopes adjacent to the heat sink, and included angles between the two slopes and a top surface of the light guiding plate is an acute angle.

Wherein the included angles between the two adjacent light guiding plates and the top surface of the light guiding plate are the same.

Wherein the light source is LED or quantum dot (QD) tube.

Wherein the backlight module further comprises a diffusion plate arranged between the optical film set and the back plate.

Wherein a plurality of supporting pillars are fixed on the light guiding plate for supporting the diffusion plate.

Wherein a dot diffusion film is provided between the two light guiding plates for covering the gap.

Wherein a side wall of the back plate comprises a first portion adjacent to the bottom of the back plate and a second portion bent outward from the first portion, and internal surfaces of the first portion and the second portion are bonded with second reflective sheets.

Wherein an acute angle between the bottom of the back plate and a bonded portion of the second reflective sheets and the first portion is not larger than 90 degrees.

Wherein a height of the bonded portion of the second reflective sheets and the first portion with respect to the bottom of the back plate is larger than a thickness of the light guiding plate.

In another aspect, a backlight module includes: a backlight module comprising a back plate having an opening on a top, first reflective sheet on a bottom of the back plate, a plurality of light guiding plates spaced apart on the first reflective sheet, a backlight source component, and an optical film set arranged over the opening on the top of the back plate, the backlight source component comprising a wedge-shaped heat sink and light sources fixed on two slopes adjacent to the heat sink, and the backlight source component being arranged within a gap between the two adjacent light guiding plates.

In view of the above, multi-pieces light guiding plates are arranged on the first reflective sheet of the back plate. The light sources are arranged within the gap between two adjacent light guiding plates, which greatly reduces the width and the thickness of the backlight module. As such, the backlight module may be adopted in large scale display devices, which may also incorporate QD technology so as to decrease the number of the light sources to reduce the cost. At the same time, the dot diffusion film is arranged above the light source. The bottom of the optical films is bonded with the diffusion plate, which provides better consistent backlight and contributes to the reduction of light-mixing distance. The back plate and the sidewall adjacent to the bottom of the back plate are bonded with reflective sheet. In addition by configuring the height and the tilt angle of the reflective sheet, the dark stripes in a rim of the backlight module may be efficiently eliminated.

### BRIEF DESCRIPTION OF THE DRAWINGS

FIG. 1 is a schematic view of the backlight module in accordance with a first embodiment.

FIG. 2 is a cross-sectional view of the backlight module in accordance with a first embodiment.

FIG. 3 is a cross-sectional view of the backlight module in accordance with a second embodiment.

### DETAILED DESCRIPTION OF THE EMBODIMENTS

Embodiments of the invention will now be described more fully hereinafter with reference to the accompanying drawings, in which embodiments of the invention are shown.

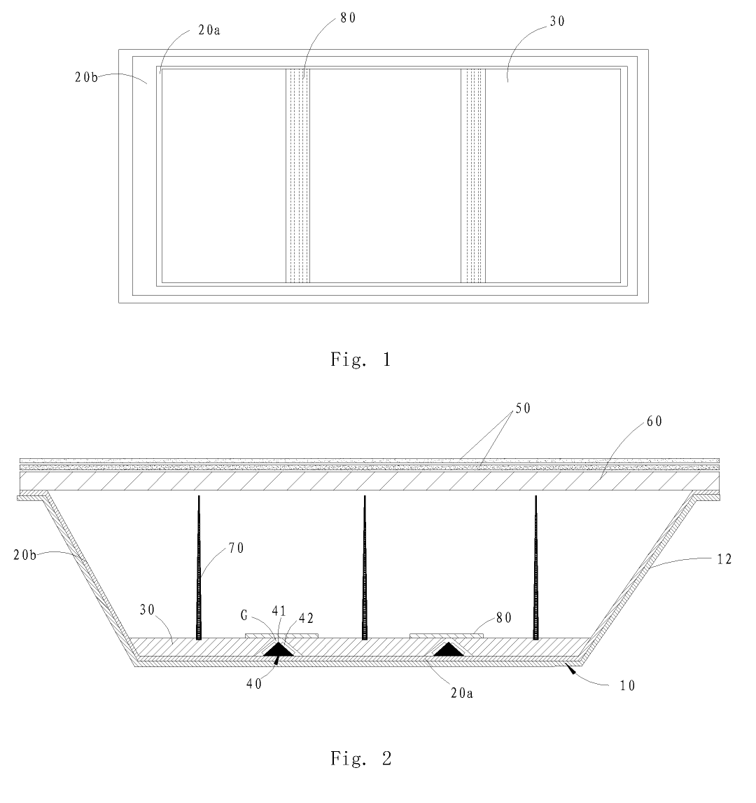

Referring to FIGS. 1 and 2, the backlight module includes a back plate 10, a first reflective sheet 20a on a bottom surface of the back plate 10, a multiple-piece light guiding plate 30, a backlight source component 40, and an optical film set 50 arranged over an opening on top of the back plate 10. The backlight source component 40 includes a wedge-shaped heat sink 41 and light sources 42 fixed on two adjacent slopes. The backlight source component 40 is arranged within a gap (G) between two adjacent light guiding plates 30. The back plate 10 is horn-shaped, and the bottom and the lateral sides of the back plate 10 are respectively bonded with the first reflective sheet 20a and second reflective sheets 20b. The lateral walls of the multiple-piece light guiding plate 30 adheres to an internal surfaces of the second reflective sheets 20b, and the two lateral surfaces of the multiple-piece light guiding plate 30 is spaced apart from each other.

The light source 42 of the backlight source component 40 is arranged within the gap (G) between two adjacent light guiding plates 30. In the embodiment, the cross-section of the heat sink 41 is an equilateral triangle. The edge surfaces of the two adjacent multiple-piece light guiding plate 30 are slopes, and are respectively parallel to the two slopes adjacent to the heat sink 41. The included angle between the two slopes and the top surface of the light guiding plate 30 is an acute angle equaling to 45 degrees. With such configuration, the light beams passing through the backlight source component 40 and emitting toward the light guiding plates 30 at two sides is uniform. The light source 42 may be LED or QD tube. The light beams emitted from the light source 42 may vertically enter the light guiding plate 30. In the embodiment, the heat sink 41 within each of the gap (G) may be integrally formed or may be individual components arranged along a lengthy direction of the gap (G), and the heat sinks 41 are spaced apart from each other.

A diffusion plate 60 is arranged over the opening of the back plate 10. The diffusion plate 60 adheres to a back surface of the optical film set 50. A plurality of supporting pillars 70 are fixed on the up surface of the light guiding plate 30, and the supporting pillars 70 are spaced apart from each other. The supporting pillars 70 are vertical to the light guiding plate 30, and extends until the opening the back plate 10. The edge of the supporting pillars 70 is spaced apart from the diffusion plate 60 for supporting the diffusion plate 60, and the diffusion plate 60 is prevented from being deformed.

In addition, the joining portion of two light guiding plates 30 may have a higher brightness, and the thickness of the edges of the light incident surface is larger. In the embodiment, a dot diffusion film 80 is adhered to the joining portion of the light guiding plates 30. A plurality of scattering dots for providing the scattering functions is arranged on the surface of the dot diffusion film 80. The dot diffusion film 80 is above the light source 42 and covers the gap (G). The light beams emitted from the top of the light source 42 may uniformly emit out after passing the dot diffusion film 80 such that the backlight performance may not be affected by the gap (G) between the light guiding plates 30, which may reduce the light-mixing distance, that is, the distance between the light guiding plate 30 and the diffusion plate 60.

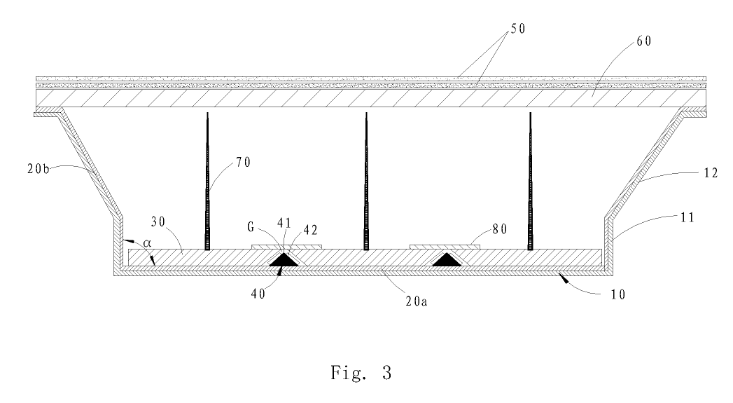

The sidewall of the back plate 10 and the structure of the second reflective sheets 20b adhering to the sidewall in the second embodiment, as shown in FIG. 3, is different from that of the first embodiment.

When the light-mixing distance is decreased to some extent, i.e., less than 20 mm, light and dark stripe may occur in a rim of the backlight module. In order to enhance the optical performance, the side wall of the back plate 10 includes a first portion 11 adjacent to the bottom of the back plate 10 and a second portion 12 bent outward so as to form an horn-shaped opening. The internal surfaces of the first portion 11 and the second portion 12 are bonded with second reflective sheets 20b. In an embodiment, the shape of the side wall of the 100 is substantially the same with the second reflective sheets 20b, and the acute angle (α) between the bottom of the back plate 10 and the bonded portion of the second reflective sheets 20b and the first portion 11 is not larger than 90 degrees. The height of the bonded portion of the second reflective sheets 20b and the first portion 11 with respect to the bottom of the back plate 10 is larger than the thickness of the light guiding plate 30. The bonded portion of the second reflective sheets 20b and the first portion 11 is spaced apart from the light guiding plate 30. In addition, the bonded portion of the first portion 11 and the second reflective sheets 20b with respect to the bottom of the back plate 10 is higher than the thickness of the light guiding plate 30 for at least 2 mm. With such configuration, the light beams irradiate on the bonded portion of the second reflective sheets 20b and the first portion 11 may not emit out from the light emitting surface, which avoids the bright and dark stripe in a rim of conventional reflective sheet.

In view of the above, the width and the thickness of the backlight module may be efficiently reduced so as to achieve the narrow border and super thin design. As such, the backlight module may be adopted in large scale display devices, which may also incorporate QD technology so as to decrease the number of the light sources to reduce the cost. At the same time, the dot diffusion film is arranged above the light source. The bottom of the optical films is bonded with the diffusion plate, which provides better consistent backlight and contributes to the reduction of light-mixing distance. The back plate and the sidewall adjacent to the bottom of the back plate are bonded with reflective sheet. In addition by configuring the height and the tilt angle of the reflective sheet, the dark stripes in a rim of the backlight module may be efficiently eliminated.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a back plate having an opening on a top, first reflective sheet on a bottom of the back plate, a plurality of light guiding plates spaced apart on the first reflective sheet, a backlight source component, and an optical film set arranged over the opening on the top of the back plate, the backlight source component comprising a wedge-shaped heat sink and light sources fixed on two slopes adjacent to the heat sink, and the backlight source component being arranged within a gap between the two adjacent light guiding plates.

2. The backlight module claimed in claim 1, wherein the two surfaces of the two light guiding plates facing toward each other are respectively parallel to the two slopes adjacent to the heat sink, and included angles between the two slopes and a top surface of the light guiding plate is an acute angle.

3. The backlight module claimed in claim 2, wherein the included angles between the two adjacent light guiding plates and the top surface of the light guiding plate are the same.

4. The backlight module claimed in claim 1, wherein the light source is LED or quantum dot (QD) tube.

5. The backlight module claimed in claim 1, wherein the backlight module further comprises a diffusion plate arranged between the optical film set and the back plate.

6. The backlight module claimed in claim 5, wherein a plurality of supporting pillars are fixed on the light guiding plate for supporting the diffusion plate.

7. The backlight module claimed in claim 1, wherein a dot diffusion film is provided between the two light guiding plates for covering the gap.

8. The backlight module claimed in claim 1, wherein a side wall of the back plate comprises a first portion adjacent to the bottom of the back plate and a second portion bent outward from the first portion, and internal surfaces of the first portion and the second portion are bonded with second reflective sheets.

9. The backlight module claimed in claim 8, wherein an acute angle between the bottom of the back plate and a bonded portion of the second reflective sheets and the first portion is not larger than 90 degrees.

10. The backlight module claimed in claim 8, wherein a height of the bonded portion of the second reflective sheets and the first portion with respect to the bottom of the back plate is larger than a thickness of the light guiding plate.

11. The backlight module claimed in claim 2, wherein a side wall of the back plate comprises a first portion adjacent to the bottom of the back plate and a second portion bent outward from the first portion, and internal surfaces of the first portion and the second portion are bonded with second reflective sheets.

12. The backlight module claimed in claim 11, wherein an acute angle between the bottom of the back plate and a bonded portion of the second reflective sheets and the first portion is not larger than 90 degrees.

13. The backlight module claimed in claim 11, wherein a height of the bonded portion of the second reflective sheets and the first portion with respect to the bottom of the back plate is larger than a thickness of the light guiding plate.

14. The backlight module claimed in claim 3, wherein a side wall of the back plate comprises a first portion adjacent to the bottom of the back plate and a second portion bent outward from the first portion, and internal surfaces of the first portion and the second portion are bonded with second reflective sheets.

15. The backlight module claimed in claim 14, wherein an acute angle between the bottom of the back plate and a bonded portion of the second reflective sheets and the first portion is not larger than 90 degrees.

16. The backlight module claimed in claim 14, wherein a height of the bonded portion of the second reflective sheets and the first portion with respect to the bottom of the back plate is larger than a thickness of the light guiding plate.

17. The backlight module claimed in claim 7, wherein a side wall of the back plate comprises a first portion adjacent to the bottom of the back plate and a second portion bent outward from the first portion, and internal surfaces of the first portion and the second portion are bonded with second reflective sheets.

18. The backlight module claimed in claim 17, wherein an acute angle between the bottom of the back plate and a bonded portion of the second reflective sheets and the first portion is not larger than 90 degrees.

19. The backlight module claimed in claim 17, wherein a height of the bonded portion of the second reflective sheets and the first portion with respect to the bottom of the back plate is larger than a thickness of the light guiding plate.

20. A backlight module, comprising:
a backlight module comprising a back plate having an opening on a top, first reflective sheet on a bottom of the back plate, a plurality of light guiding plates spaced apart on the first reflective sheet, a backlight source component, and an optical film set arranged over the opening on the top of the back plate, the backlight source component comprising a wedge-shaped heat sink and light sources fixed on two slopes adjacent to the heat sink, and the backlight source component being arranged within a gap between the two adjacent light guiding plates.
